(19) United States
(12) Patent Application Publication
(10) Pub. No.: US 2016/0379591 A1
(43) Pub. Date: Dec. 29, 2016

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: Takashi Oya, Yokohama-shi (JP)

(21) Appl. No.: 15/184,808

(22) Filed: Jun. 16, 2016

(30) Foreign Application Priority Data
Jun. 24, 2015 (JP) 2015-126862

(51) Int. Cl. G09G 5/00; G02B 27/01; G06T 19/20; G06T 19/00; G06T 7/00

(52) U.S. Cl. CPC G09G 5/006; G06T 19/006; G06T 7/004; G06T 19/20; G02B 27/017; G02B 27/0101; G06T 2200/04; G02B 2027/0138; G02B 2027/014

(57) ABSTRACT

An information processing apparatus connected to a first display apparatus that is mounted on or held with one portion of a body of a first user and displays a virtual object and to a second display apparatus that is mounted on or held with one portion of a body of a second user different from the first user and displays an image corresponding to an image displayed on the first display apparatus includes a determination unit configured to determine whether the body of the first user or an object held by the first user satisfies a predetermined condition, and an output unit configured, if the determination unit determines that the body of the first user or the object held by the first user satisfies the predetermined condition, to output a determination result to the second display apparatus.

### BACKGROUND OF THE INVENTION

Field of the Invention

The present invention relates to an information processing apparatus, a control method, and a storage medium.

Description of the Related Art

A layout tool using a mixed reality (MR) system in which a real space and a virtual space are seamlessly combined has been introduced to shorten a layout process period. and reduce costs in the field of manufacturing. In the mixed reality system, a head-mounting-type display (hereinafter called a head-mounted display (HMD)) that is integration of a display and an image capturing apparatus such as a video camera is used as one example of a video display unit. According to the mixed reality system, a product under development is expressed by computer graphics (CG), and the CG image or video and a real-world video are superimposed to display the resultant video on the HELD. As a result, a state of the product can be checked from an optional viewpoint. This enables, for example, design of the product to be examined without making a full-scale model.

In a layout process in a manufacturing industry, a review meeting in which a number of people participate is often held. On the other hand, in a review using mixed reality, a system including an HMD and a combination of handy information terminals such as tablet terminals, is used so that a number of people experience a mixed reality space. Such a system simultaneously delivers/displays a mixed reality video being viewed by an HMD user to/on a plurality of tablet terminal screens. This enables a plurality of people to simultaneously share the field of view of the HMD user and participate in layout/examination.

According to the mixed reality system, a work process in a factory can be checked in advance. For example, a product in the process of assembly is expressed as a virtual object, and a person who experiences the mixed reality system holds a model of an instrument such as an electric screwdriver. Then, the mixed reality system determines interference between the virtual object and the model, in the mixed reality space, thereby checking the presence or absence of a problem in the work process. An interference area can be highlighted or a vibration device installed in the model can be vibrated as an output example of an interference determination result.

Japanese Patent Application Laid-Open No. 2006-293604 discusses an example of group work using a mixed reality system. The mixed reality system discussed in Japanese Patent Application Laid-Open No. 2006-293604 enables a plural of participants to remotely share a mixed reality space of a worker and to work as a group by perceiving a real object and a virtual object without a seam while changing a viewpoint.

In a mixed reality system, an HMD user may use an actual instrument to check a work process, and an HMD video may be shared among a plurality of tablet terminals. In such a case, the instrument can be a model. Moreover, the position and orientation of the instrument is reproduced in a mixed reality space, so that a state of interference with a virtual object is determined. The interference state is output by, for example, highlighting an interference area and using a vibration device attached to the instrument. If the interference area is provided outside the visual field of the HMD, and if the interference area is hidden by the virtual object and not directly visible, a tablet terminal user is unable to know the interference state.

### SUMMARY OF THE INVENTION

According to an aspect of the present invention, an information processing apparatus is connected to a first display apparatus that is mounted on or held with one portion of a body of a first user and displays a virtual object and to a second display apparatus that is mounted on or held with one portion of a body of a second user different from the first user and displays an image corresponding to an image displayed on the first display apparatus, and includes a determination unit configured to determine whether the body of the first user or an object held by the first user satisfies a predetermined condition, and an output unit configured, if the determination unit determines that the body of the first user or the object held by the first user satisfies the predetermined condition, to output a determination result to the second display apparatus.

According to the description of this specification, a state of interference between a virtual object and a real object can be shared in a realistic manner.

Further features of the present invention will become apparent from the following description of exemplary embodiments with reference to the attached drawings.

### BRIEF DESCRIPTION OF THE DRAWINGS

FIG. 1 is a diagram illustrating one example of a system configuration of a mixed reality system.

FIG. 2 is a diagram illustrating one example of a common hardware configuration.

FIG. 3 is a diagram illustrating one example of the mixed reality system in detail according to a first exemplary embodiment of the present invention.

FIG. 4 is a diagram illustrating vibration sharing of a tablet terminal.

FIG. 5 is a diagram illustrating one example of a software configuration according to the first exemplary embodiment.

FIG. 6 is a flowchart illustrating one example of information processing according to the first exemplary embodiment.

FIG. 7 is a diagram illustrating one example of a mixed reality system in detail according to a second exemplary embodiment of the present invention.

FIGS. 8A and 8B are diagrams each illustrating one example of a head-mounted display (HMD) video.

FIG. 9 is a diagram illustrating one example of a software configuration according to the second exemplary embodiment.

FIG. 10 is a flowchart illustrating one example of information processing according to the second exemplary embodiment.

### DESCRIPTION OF THE EMBODIMENTS

Hereinafter, exemplary embodiments of the present invention are described with reference to the drawings.

A first exemplary embodiment of the present invention is described using an example case in which an HMD user who experiences mixed reality operates an instrument. In a mixed reality system of the present exemplary embodiment, an HMD video of the HMD user is delivered to a tablet terminal, so that a tablet terminal user shares the HMD video with the HMD user. Here, in the mixed reality system of the present exemplary embodiment, the instrument may interfere with a virtual object in a mixed reality space. In such a case, a vibration device attached to the tablet terminal which is sharing the HMD video is operated. This enables an interference state in a virtual space to be intuitively shared between the HMD user and the tablet terminal user even if the interference area is provided outside the visual field or even if the interference area is provided within the visual field but hidden by the virtual object.

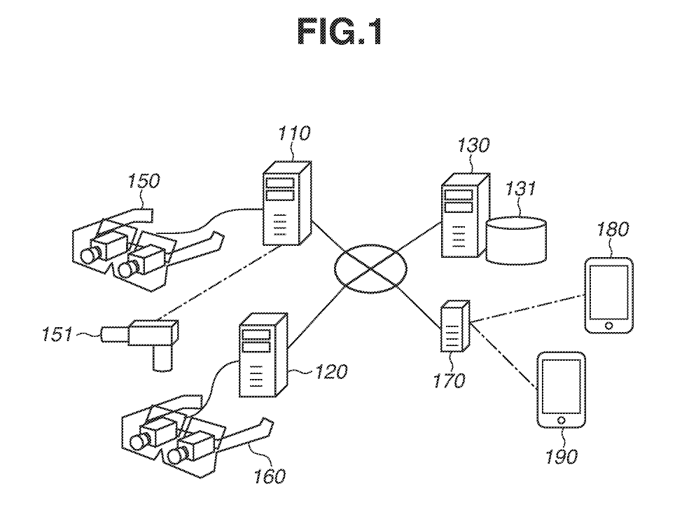

FIG. 1 is a diagram illustrating one example of a system configuration of the mixed reality system. The mixed reality system according to the present exemplary embodiment includes HMDs 150 and 160, HMD control apparatuses. 110 and 120, and an instrument 151 equipped with a vibration device. Moreover, the mixed reality system according to the present exemplary embodiment includes a tablet terminal 180 equipped with a vibration device, a tablet terminal 190 equipped with a vibration device, and a scene data management server 130. Each of the HMDs 150 and 160 serves as a mixed reality display device. The HMDs 150 and 160 are respectively connected to the HMD control apparatuses 110 and 120 for performing operations such as power supply, control, communication, and display video combination. The tablet terminals 180 and 190 display videos from the HMDs 150 and 160 in a sharing manner. The scene data management server stores/manages scene data 131 for providing a virtual space. The scene data 131 includes data of a virtual object. The tablet terminals 180 and 190, the HMD control apparatuses 110 and 120, and the scene data management server 130 are connected via a network.

Each of the tablet terminals 180 and 190 is connected to the network regardless of wired or wireless configuration. As illustrated in FIG. 1, the tablet terminals 180 and 190 can be connected to the network via a wireless local area network (LAN) access point 170. Alternatively, the tablet terminals 180 and 190 can be connected to the network via the Internet. The HMD control apparatuses 110 and 120 and the scene data management server 130 can use personal computers (PCs). Thus, the HMD control apparatus 110 and the scene data management server 130 can use the same PC. Each of the tablet terminals 180 and 190 can use a desktop PC or a notebook PC. The instrument 151 is equipped with the vibration device that is connected to the HMD control apparatuses 110 and 120 by short-range wireless communication such as Bluetooth (registered trademark).

In the present exemplary embodiment, each of the HMDs 150 and 160 includes an image capturing apparatus and a display apparatus. Moreover, each of the HMDs 150 and 160 is described as a video see-through type that displays a combined image on the display apparatus, the combined image being acquired by superimposing a CC image on an image captured by the image capturing apparatus. However, an optical see-through type that superimposes a CC image on a transmission-type optical display can be used.

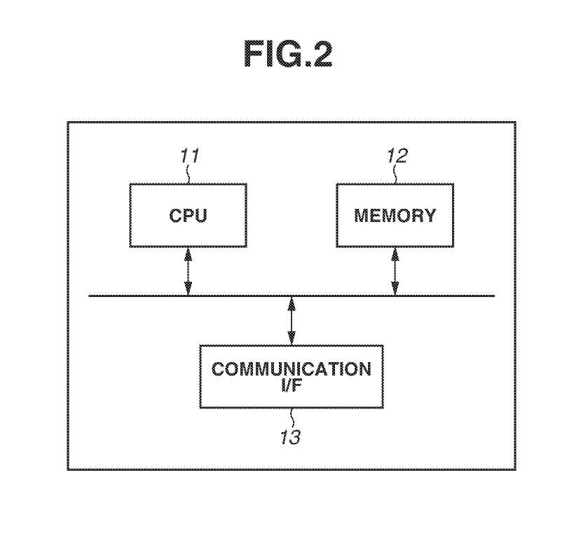

Hereinafter, a common configuration for hardware such as the HMD control apparatuses 110 and 120, the tablet terminals 180 and 190, and the scene data management server 130 is described with reference to FIG. 2 that illustrates one example of a common hardware configuration of an apparatus forming the mixed reality system. As illustrated in FIG. 2, the apparatus forming the mixed reality system includes at least a central processing unit (CPU) 11, memory 12, and a communication interface (I/F) 13 as hardware. The CPU 11 executes processing based on a program stored in the memory 12 to provide a software configuration of each device described below and perform processing of a flowchart described below. The memory 12 stores a program and various pieces of data that is used when the CPU 11 executes processing. The communication I/F connects the apparatus to a network to allow communication with other apparatuses. In FIG. 2, one CPU 11, one memory 12, and one communication i/F 13 are arranged. However, a plurality of CPUs, memories, or communication I/Fs may be arranged.

Moreover, each of the apparatuses forming the mixed reality system has the hardware configuration illustrated in FIG. 2 as a basic configuration, and includes other hardware depending on the apparatus. For example, the HMD further includes hardware such as an image capturing unit and a display unit in addition to the basic configuration. Moreover, the tablet terminal further includes hardware such as a display unit, an input unit, and a vibration device in addition to the basic configuration.

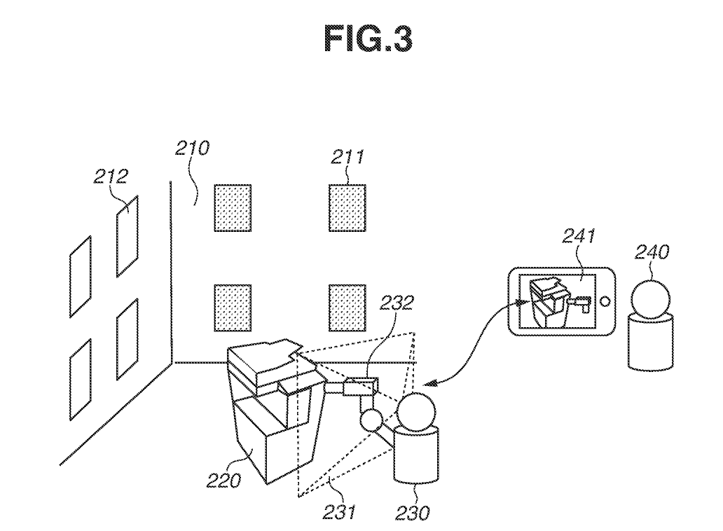

FIG. 3 is a diagram illustrating one example of the mixed reality system in detail according to the first exemplary embodiment. In a mixed reality space 210, markers 211 and 212 for alignment are arranged on the wall or floor. Moreover, a virtual object 220 is arranged in a center portion on the floor. When an HMD user 230 wears the HMD 150 (not illustrated in FIG. 3) and observes a mixed reality space, a mixed reality video in which the virtual object 220 of a three-dimensional CG model and a photographed image are superimposed is displayed on a display unit of the HMD 150. In a projected area 231 illustrated in FIG. 3, an image being viewed by the observer via the HMD 150 is virtually displayed. The video of the projected area 231 is output to the HMD 150, and delivered to a tablet terminal 241 connected to the system. A tablet terminal user 240 shares the mixed reality space via a screen of the tablet terminal 241.

The HMD user 230 holds an instrument 232 to interact with the virtual object. The position and orientation of the instrument 232 is measured using, for example, an optical sensor or a marker attached to the instrument 232. The HMD user 230 observes the instrument 232 in a state where a image superimposed on the instrument 232 is combined with a photographed image. If the instrument 232 interferes with the virtual object, the mixed reality system detects the interference. Upon detection of the interference, the mixed reality system vibrates, a vibration device attached to the instrument 232 to notify the HMD user 230 of an interference determination result.

In the mixed reality system according to the first exemplary embodiment, a mixed reality video is shared between the HMD and the tablet terminal 241, the mixed reality video being a mixture of the virtual object 220 and the real space displayed on the HMD within the visual field of the HMD user. The mixed reality system determines whether interference between the instrument 232 of the HMD user in the real space and the virtual object 220 has occurred. If the mixed reality system determines that the interference has occurred, the user of the tablet terminal 241 is notified that the interference has occurred. This enables the user of the tablet terminal 241 to know a state of the interference between the virtual object 220 and the real object in a realistic manner.

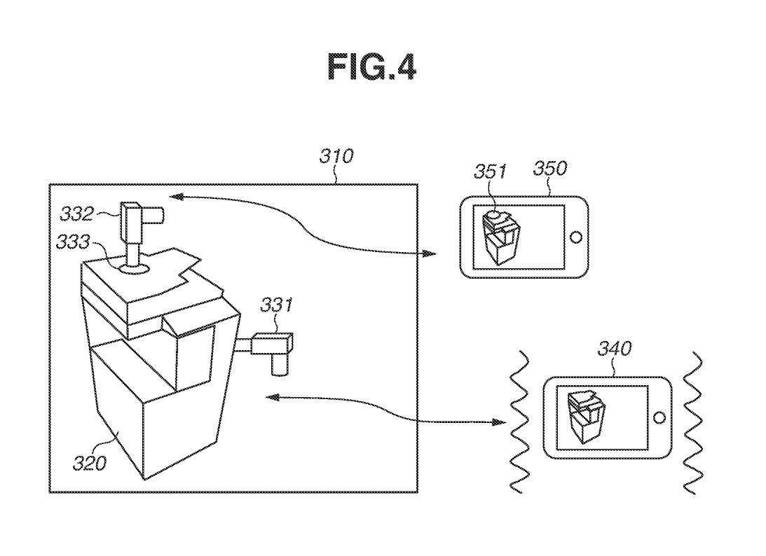

FIG. 4 is a diagram illustrating vibration sharing of a tablet terminal. In FIG. 4, a virtual object 320 and an instrument, which are within the visual field, are provided on a screen 310 for the HMD user. When the instrument contacts the virtual object 320, a tablet terminal vibrates. Here, the mixed reality system determines whether to vibrate the instrument based on a positional relationship between a viewpoint of the HMD user and a contact area between the instrument and the virtual object 320. For example, a contact area between an instrument 331 and the virtual object 320 may be provided on a backside of the virtual object 320, and may not be directly visible. In such a case, the mixed reality system vibrates the tablet terminal 340. On the other hand, an instrument 332 and a contact area may be visible. In such a case, the mixed reality system highlights the contact area as a highlighted area 333. As a result, a highlighted area 351 is visible to a user of a tablet 350. Thus, the user of the tablet 350 can perceive a contact state without vibration sharing.

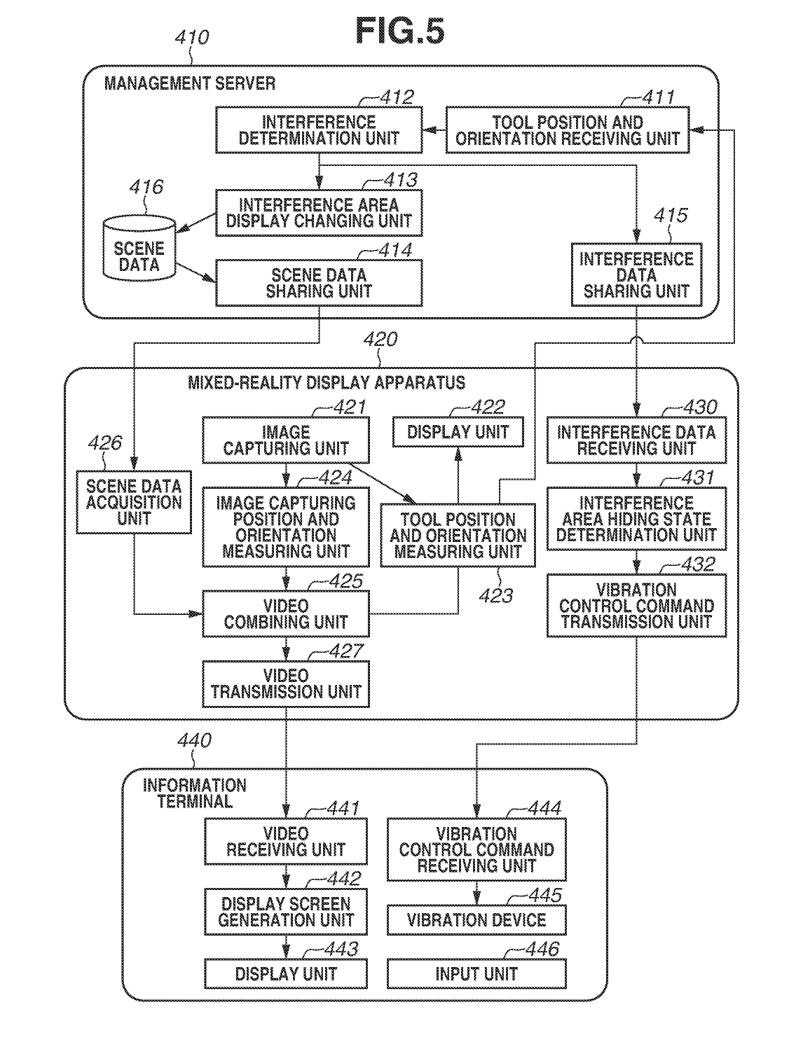

FIG. 5 is a diagram illustrating one example of a software configuration of each of the apparatuses forming the mixed reality system according to the first exemplary embodiment. The mixed reality system includes a management server 410, a mixed-reality display apparatus 420, and an information terminal 440. The management server 410 corresponds to the scene data management server 130. The mixed-reality display apparatus 420 corresponds to the HMD 150 and the HMD control apparatus 110, the HMD 160 and the HMD control apparatus 120, the HMD 150, or the HMD 160. The information terminal 440 corresponds to each of the tablet terminals 180 and 190.

The mixed-reality display apparatus 420 includes an image capturing unit 421 and a display unit 422 as a hardware configuration. Moreover, the mixed-reality display apparatus 420 includes an image capturing position and orientation measuring unit 424, scene data acquisition unit 426, a video combining unit 425, a video transmission unit 427, and a tool position and orientation measuring unit 423 as a software configuration. Moreover, the mixed-reality display apparatus 420 further includes an interference data receiving unit 430, an interference area hiding state determination unit 431, and a vibration control command transmission unit 432 as a software configuration. One example of a tool is an instrument held by an HMD user.

The image capturing unit 421 uses an image capturing device such as a camera to input a real image. The image capturing position and orientation measuring unit. 424 acquires a three-dimensional position and orientation within a mixed reality space of the mixed-reality display apparatus 420. The image capturing position and orientation measuring unit 424, for example, estimates a position and orientation from a marker in a real space or information about characteristic point. The image capturing position and orientation measuring unit 424 can use information of a sensor such as an infrared sensor, a magnetic sensor, or a gyro sensor connected to the mixed-reality display apparatus 420 to acquire the position and orientation, or can use a combination of the above methods. Similarly, the tool position and orientation measuring unit 423 acquires a three-dimensional position and orientation of the tool within a mixed reality space, and transmits the acquired position and orientation to the management server 410.

The scene data acquisition unit 426 acquires scene data 416 from the management server 410, and stores the acquired scene data 416 as scene data in the mixed-reality display apparatus 420. The video combining unit 425 generates an apparent image of a virtual object from the scene data based on position and orientation information to generate a video that is superimposed on a photographed image acquired by the image capturing unit 421. The generated video is displayed on the display unit 422. As a result, a user of the mixed-reality display apparatus 420 can experience mixed reality as if the virtual object were present in the real space. The video generated by the video combining unit 425 is transmitted to the information terminal 440 via the video transmission unit 427. That is the video transmission unit 427 has a function to output a result of an interference.

The interference data receiving unit 430 receives interference data from an interference data sharing unit 415 of the management server 410. Subsequently, the interference area hiding state determination unit 431 determines a hiding state of the interference area. The interference area hiding state determination unit 431 determines whether the interference area is directly visible from a position of the HMD. For example, the interference area hiding state determination unit 431 determines whether a first intersection of a virtual object and a line segment toward the center of the interference area from a position of the HMD as a starting point is in the interference area to determine whether the interference area is directly visible from the position of the HMD. The vibration control command transmission unit 432 transmits a vibration control command to a vibration device 445 of the information terminal 440 based on a determination result acquired by the interference area hiding state determination unit 431.

The information terminal 440 includes a display unit 443, an input unit 446, and the vibration device 445 as a hardware configuration. Moreover, the information terminal 440 includes a video receiving unit 441, a display screen generation unit 442, and a vibration control command receiving unit 444 as a software configuration.

The video receiving unit 441 receives an HMD video from the management server 410. The display screen generation unit. 442 generates a display screen based on the HMD video to display the video on the display unit 443. The vibration control command receiving unit 444 receives a vibration control command transmitted from the vibration control command transmission unit 432 of the mixed-reality display apparatus 420, and vibrates the vibration device 445 based on the vibration control command. The input unit 446 receives an input from a user of the information terminal 440.

The management server 410 manages and delivers scene data. The management server 410 includes a tool position and orientation receiving unit 411, an interference determination unit (a determination unit) 412, an interference area display changing unit 413, a scene data sharing unit (an output unit) 414, and the interference data sharing unit (an output unit) 415 as a software configuration.

The tool position and orientation receiving unit 411 acquires a position and orientation of a tool (an instrument) operated by an HMD user. The interference determination unit 412 makes a determination of contact/interference between the virtual object and the instrument based on virtual object information managed by the management server 410 and the tool position and orientation received by the tool position and orientation receiving unit 411. The interference determination unit 412 makes the interference determination based on whether a component of the virtual object and a component of the instrument are provided in the same space within a three-dimensional space. If the component of the virtual object and the component of the instrument are provided in the same space within the three-dimensional space, the interference determination unit. 412 determines that the interference occurs. If the interference determination unit 412 determines that the interference occurs, the interference area display changing unit 413 highlights an interference area. For example, the interference area display changing unit 413 changes and draws a thickness or color of a line of a closed surface including a nodal line of three-dimensional components to highlight the line, or fills a surface forming the entire interfering component with different color to highlight the surface.

The scene data sharing unit 414 transmits the scene data 416 to the mixed-reality display apparatus 420 and the information terminal 440. Moreover, the scene data sharing unit 414 transmits the highlighted data to the mixed-reality display apparatus 420 and the information terminal 440. The interference data sharing unit transmits information about the presence or absence of the interference area to the mixed-reality display apparatus 420 and the information terminal 440 to share the information. In the FIG. 5, however the scene data sharing unit 414 and the interference data sharing unit 415 transmit data to the information terminal 440 via the mixed-reality display apparatus 420, and the scene data sharing unit 414 and the interference data sharing unit 415 transmit data to the information terminal 440 directly without via the mixed-reality display apparatus 420.

Moreover, each of the management server 410, the mixed-reality display apparatus 420, and the information terminal 440 includes a connection control unit (not illustrated) so that a video sharing state is collectively managed by the management server 410.

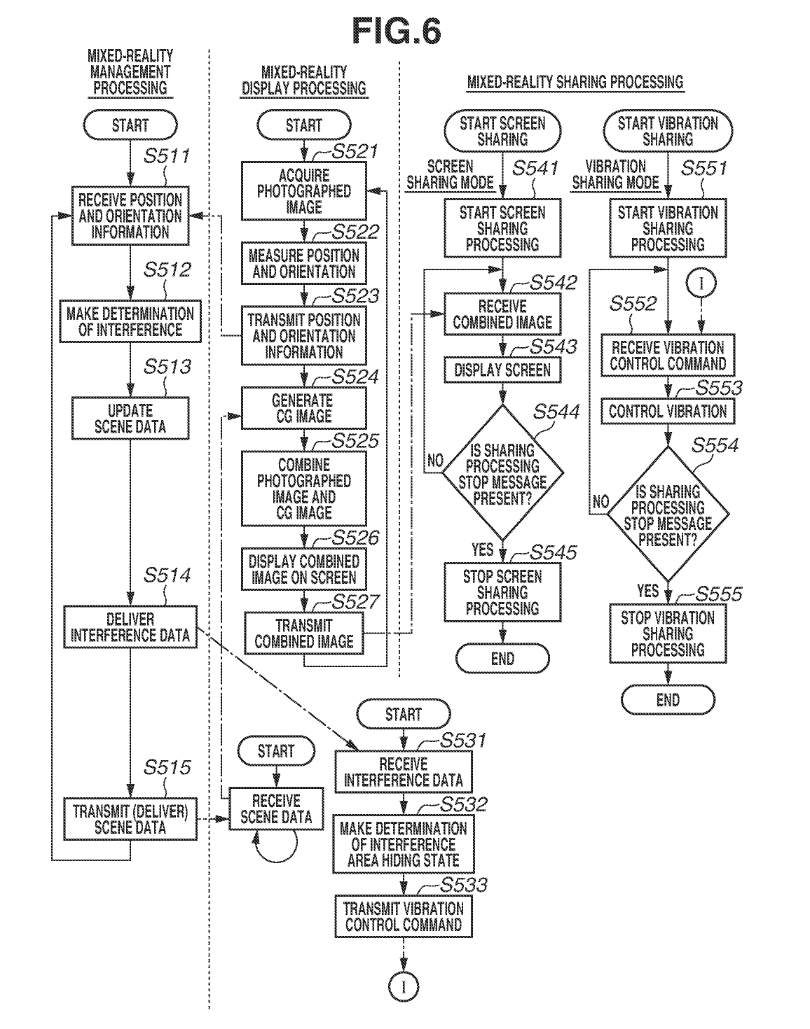

FIG. 6 is a flowchart illustrating one example of information processing performed by the mixed reality system according to the first exemplary embodiment. In the information processing performed by the mixed reality system, the management server 410, the mixed-reality display apparatus 420, and the information terminal 440 cooperate with one another. For a start of the information processing, assume that a user has already designated which video of the mixed-reality display apparatus 420 is to be shared with the information terminal 440. In FIG. 6, only processing necessary for the present exemplary embodiment is described, and description of processing such as activation, initialization, and termination is omitted.

The management server 410 executes information processing from step S511 to step S515. After the information processing is started, the processing proceeds to step S511 in which the management server 410 receives position and orientation information of a tool from the mixed-reality display apparatus 420 to update a display state. Subsequently, in step S512, the management server 410 makes a determination of interference between the tool (hereinafter also called an instrument) and a virtual object. In step S513, if the management server 410 determines that the instrument and the virtual object interfere, the management server 410 changes a display attribute of the interference area in scene data such that the interference area is highlighted. Moreover, the management server 410 changes scene data based on a measurement result of the position and orientation of the tool. Subsequently, in step S514, the management server 410 delivers interference data including the presence or absence of the interference area to the mixed-reality display apparatus 420. In step S515, the management server 410 transmits updated scene data to the mixed-reality display apparatus 420.

The mixed-reality display apparatus 420 executes information processing from step S521 to step S533. After the information processing is started, scene data receiving processing in step S530, interference data receiving processing from step S531 to step S533, and mixed-reality display processing from step S521 to step S527 are executed in parallel.

As for the mixed reality display processing, in step S521, the mixed-reality display apparatus 420 acquires a photographed image from the image capturing unit 421. Subsequently, in step S522, the mixed-reality display apparatus 420 acquires a position and orientation of a tool. In step S523, the mixed-reality display apparatus 420 transmits the position and orientation of the tool to the management server 410. In step S524, the mixed-reality display apparatus 420 generates a CG image of a virtual object from scene data. The mixed-reality display apparatus 420 acquires the scene data from the management server 410 in the scene data receiving processing in step S530.

In step S525, the mixed-reality display apparatus 420 combines the photographed image and the CG image. In step S526, the mixed-reality display apparatus 420 displays the combined image on the display unit 422. In step S527, the mixed-reality display apparatus 420 transmits the displayed image (or the screen) to the information terminal 440. Subsequently, the processing returns to step S521. In step S521, the mixed-reality display apparatus 420 continues the information processing. When transmitting an image, the mixed-reality display apparatus 420 can code the image, by use of, for example, Joint Photographic Experts Group (JPEG) and H. 264 to transmit the corded image. Alternatively, the mixed-reality display apparatus 420 can use a streaming protocol such as a real-time transport protocol (RTP) to transmit the image.

In interference data processing, in step S531, the mixed-reality display apparatus 420 receives the interference data from the management server 410. Subsequently, in step S532, the mixed-reality display apparatus 420 makes a determination of a hiding state of an interference area. In step S533, if the mixed-reality display apparatus 420 determines that the interference area is not directly visible from a position of the HMD as a result of the determination, the mixed-reality display apparatus 420 transmits a vibration control command including a vibration command to the information terminal 440.

The information terminal 440 executes information processing from step S541 to step S555 that includes screen sharing processing and vibration sharing processing. In step S541, the information terminal 440 starts the screen sharing processing. In step S542, the information terminal 440 receives the combined image from the mixed-reality display apparatus 420. Here, if coded image data received, the information terminal 440 decodes the coded image data. Subsequently, in step S543, the information terminal 440 generates a display screen to display the generated screen on a display of the information terminal 440. Here, a resolution may need to be changed. In such a case, in step S543, the information terminal 440 changes the resolution. Subsequently, in step S544, the information terminal 440 determines whether a message to stop sharing processing is present. If the information terminal 440 determines that the sharing processing stop message is present (YES in step S544), the processing proceeds to step S545. If the information terminal 440 determines that the sharing processing stop message is not present (NO in step S544), the processing returns to step S542. The sharing processing stop message is resulted from a user interface operation on the information terminal by an information terminal user, and includes both of a screen sharing stop request and a vibration sharing stop request. In step S545, the information terminal 440 stops the screen sharing processing.

In step S551, the information terminal 440 starts vibration sharing processing. In step S552, the information terminal 440 receives a vibration control command from a mixed-reality display processing apparatus 520. The vibration control command may include a vibration command. In such a case, in step S553, the information terminal 440 controls the vibration device 445 to generate vibration. In step S554, the information terminal 440 determines whether a message to stop the sharing processing is present. If the information terminal 440 determines that the sharing processing stop message is present (YES in step S554), the processing proceeds to step S555. If the information terminal 440 determines that the sharing processing stop message is not present (NO in step S554), the processing returns to step S552. Such a sharing processing stop message can also be used to stop screen sharing processing. In step S555, the information terminal 440 stops the vibration sharing processing.

According to the present exemplary embodiment, therefore, in the mixed reality system allowing a mixed-reality experience video of an HMD user to be shared with an information terminal such as a tablet terminal, a state of interference or a contact between a virtual object and a real object can be shared. As a result, the mixed reality system can provide more sense of reality.

### Modification Example 1

In the present exemplary embodiment, a real instrument has been described as an object to interfere. However, the present exemplary embodiment is not limited to the real object. A model can also be used. Moreover, for example, a hand or an arm of an HMD user can be used as long as a position and orientation of the hand or the arm serving as an object to interfere can be measured. As for a hand measurement method, the mixed-reality display apparatus 420 can search for corresponding points of right and left eyes of the HMD to create a depth image, and apply the depth image to a hand model to determine a three-dimensional position and orientation of the hand.

### Modification Example 2

In the present exemplary embodiment, vibration of the tablet terminal has, been described as an example of an interference output when an interference area is hidden. However, other output methods can be used. For example, the mixed reality system can display an “interfering” icon in an area such as an interference area on a screen of a tablet terminal, or can vibrate a screen of a tablet terminal, up and down. Alternatively, the mixed reality system can cause an alarm sound indicating that interference has occurred to be output from a tablet terminal.

### Modification Example 3

In the present exemplary embodiment, a function of the management server and a function of the mixed-reality display apparatus can be integrated.

A second exemplary embodiment of the present invention is described using an example case in which two HMD users experience mixed reality. According to a mixed reality system of the second exemplary embodiment, in a case where interference between a tool (an instrument) held by a first user and a virtual object occurs, a vibration device held by a second user is vibrated. This enables the interference state of the first user to be intuitively notified to the second user. Hereinafter, the second exemplary embodiment is described by mainly referring to the difference from the first exemplary embodiment.

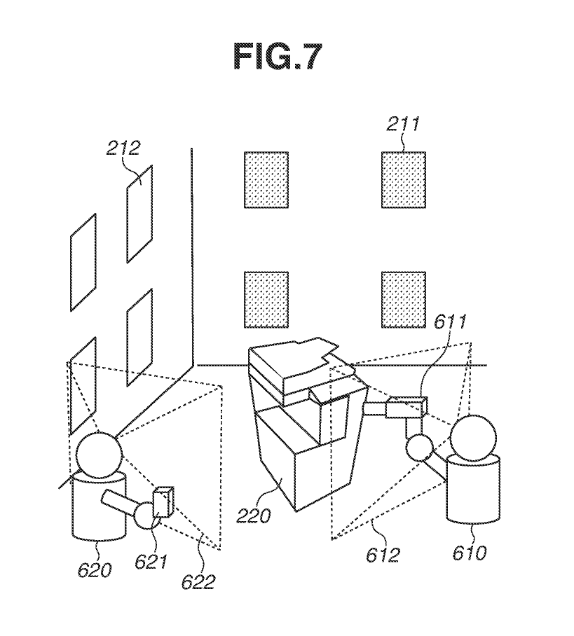

FIG. 7 is a diagram illustrating one example of the mixed reality system in detail according to the second exemplary embodiment. In a mixed reality space as illustrated in FIG. 7, markers 211 and 212 that are used for alignment are attached. Two HMD users 610 and 620 observe a virtual object 220. The first HMD user 610 holds an instrument (a tool) 611 with his/her hand. The virtual object 220 and the tool 611 are projected on an HMD projection plane 612 for the first HMD user 610. The projection plane 612 is determined by parameters such as a position and orientation, a viewing angle, and a focal length of a camera mounted on the HMD of the first HMD user 610. Similarly, the virtual object 220 and the tool 611 are also projected on an HMD projection plane 622 for the second HMD user 620. The projection plane 622 is determined by a camera mounted on the HMD of the second HMD user 620. The second HMD user 620 holds vibration apparatus 621 with his/her hand.

The mixed reality system according to the second exemplary embodiment determines whether interference between the tool 611 of the first HMD user 610 in a real space and the virtual object 220 has occurred. If the mixed reality system determines that the interference has occurred, the second HMD user 620 is notified that the interference has occurred. This enables the second HMD user 620 to know the state of interference between the virtual object 220 and the real object in a realistic manner.

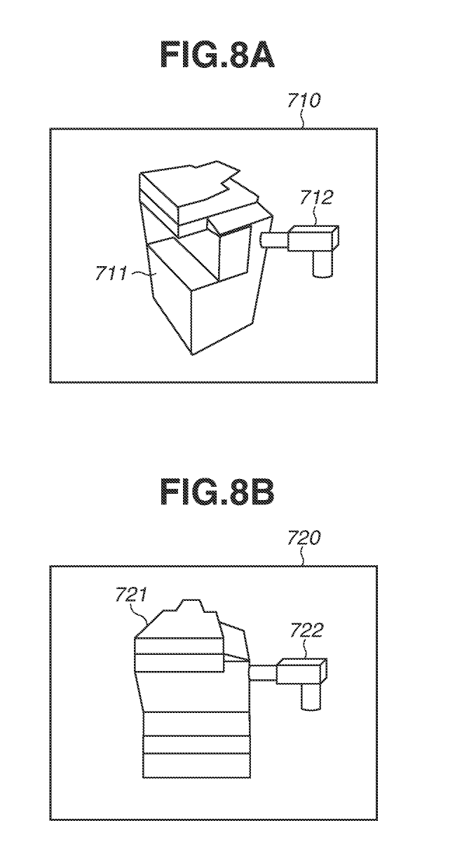

FIGS. 8A and 8B are diagrams each illustrating one example of an HMD video. In FIG. 8A, on a screen 710 for the first HMD user 610, the virtual object 220 is projected as an object 711, and the tool 611 is projected as a tool 712. In this, case, the tool 611 appears to be in contact with the object 711. Similarly, in FIG. 8B, on a screen 720 for the second HMD user 620, the virtual object 220 is projected as an object 721 and the tool 611 is provided as a tool 722 in a field of view. Accordingly, the second HMD user 620 also can check the contact area on the HMD screen. The interference state can be shared between a plurality of users by a method for highlighting the interference area using a change in CG component attribute such as color of a virtual object and a thickness of line, or a method for vibrating the vibration device 621.

According to the method vibrating the vibration device 621, if the mixed reality system determines that the tool 611 has contacted or interfered with the virtual object 220, a vibration device inside the tool 611 is vibrated to notify the first HMD user 610 of the interference. Here, if the interference area is within the visual field of the second HMD user 620, the mixed reality system vibrates the vibration device 621 in cooperation with the vibration of the vibration device of the tool 611.

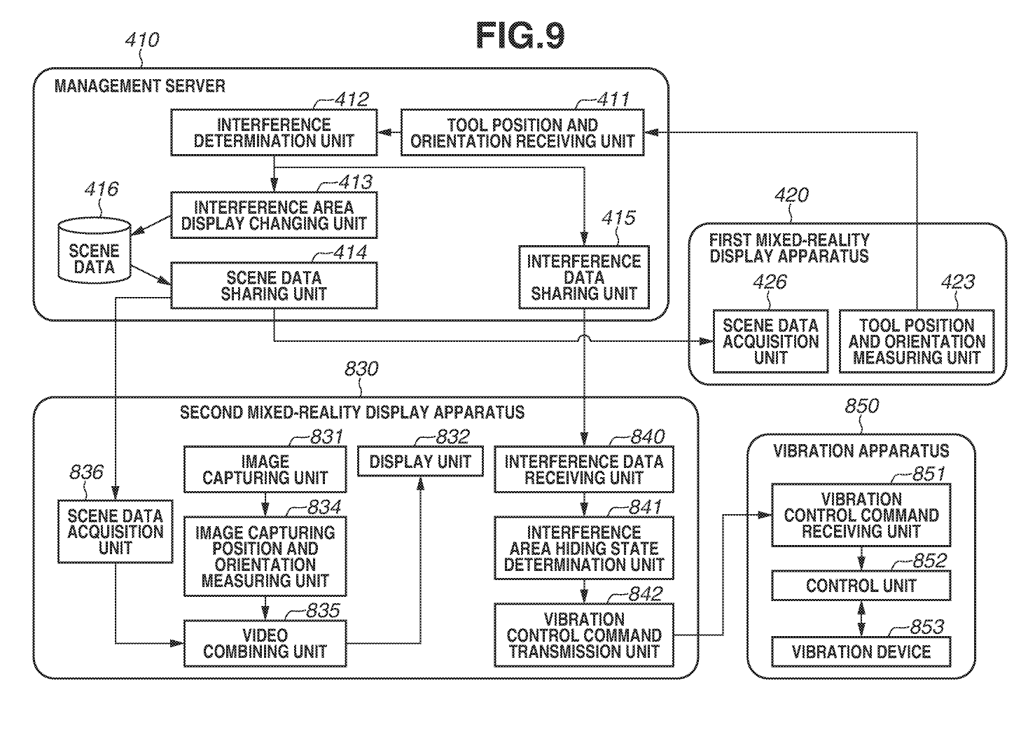

FIG. 9 is a diagram illustrating one example of a software configuration of each apparatus forming the mixed reality system according to the second exemplary embodiment. Since a configuration of the management server 410 of the second exemplary embodiment is substantially the same as that of the first exemplary embodiment, a description thereof is omitted. Moreover, a configuration of each of the first mixed-reality display apparatus 420 and a second mixed-reality display apparatus 830 is substantially the same as that of the mixed-reality display apparatus of the first exemplary embodiment except for the video transmission unit 427. In the first and second mixed reality display apparatuses 420 and 830 in FIG. 9, only components necessary for the description of the second exemplary embodiment are illustrated for the sake of simplicity.

A vibration apparatus 850 includes a vibration device 853 as a hardware configuration. The vibration apparatus 850 includes vibration control command receiving unit 851 and a control unit 852 as a software configuration.

The vibration apparatus 850 is connected to the second mixed-reality display apparatus 830 via short-range wireless communication such as Bluetooth. The vibration control command receiving unit 851 receives a vibration control command from the second mixed-reality display apparatus 830. The control unit 852 controls the vibration device 853 to generate vibration according to the vibration control command.

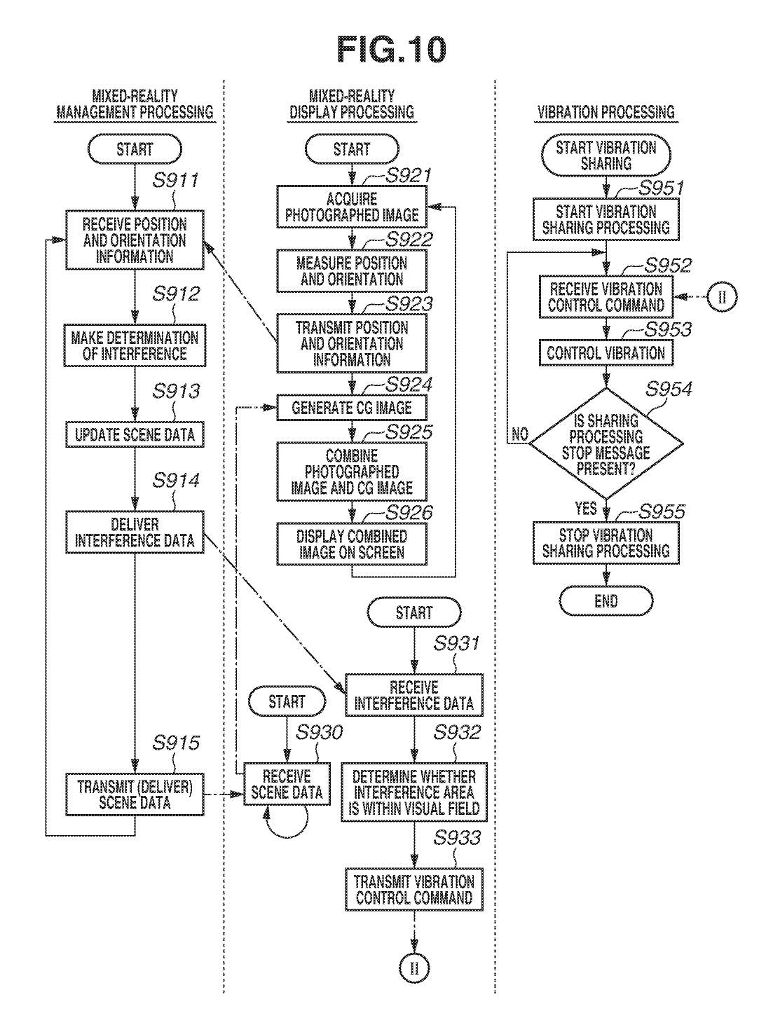

FIG. 10 is a flowchart illustrating one example of information processing performed by the mixed reality system according to the second exemplary embodiment. Processing from step S911 to step S915 in FIG. 10 is similar to that from step S511 to step S515 described above with reference to FIG. 6 in the first exemplary embodiment. Processing from step S921 to step S926 in FIG. 10 is similar to that from step S521 to step S526 in FIG. 6 of the first exemplary embodiment. Moreover, processing in step S930 in FIG. 10 is similar to that in step S530 in FIG. 6 of the first exemplary embodiment. Each of the processing from step S921 to step S926 and the processing in step S930 is executed by the first mixed-reality display apparatus 420 and the second mixed-reality display apparatus 830.

In step S931, the second mixed-reality display apparatus 830 receives interference data from the management server 410. Subsequently, in step S932, the second mixed-reality display apparatus 830 determines whether an interference area is within the visual field of a camera of the second mixed-reality display apparatus 830. In step S933, if the interference area is within the visual field, the second mixed-reality display apparatus 830 transmits a vibration control command including a vibration command to the vibration device 621. Processing from step S951 to step S955 in FIG. 10 is similar to that from step S551 to step S555 described above in FIG. 6 of the first exemplary embodiment. However, the processing from step S951 to step S955 is mainly performed by the vibration device 621. In step S955, the vibration device 621 stops the vibration sharing processing upon detection of a press on a button thereof.

According to such processing, when a plurality of people experiences a virtual reality space, an interference determination result of a first HMD user can be shared with a second HMD user in a more realistic manner.

### Modification Example 4

A video of an HMD user can be displayed on a large-screen display, so that mixed reality can be shared and viewed by a large number of people. In such a case, each of the people holds the vibration device 621 as illustrated in FIG. 7 with his/her hand. That is, a display apparatus displays a mixed video which is a mixture of a virtual object and a real space within the visual field of the user of the mixed realty display apparatus, so that the mixed video is shared among the plurality of users. In such a system, a management server determines whether the virtual object and an object of the user of the mixed-reality display apparatus in the real space have interfered. If it is determined that the object and the virtual object have interfered, the mixed-reality display processing apparatus vibrates the vibration apparatuses of the plurality of users to notify them of the interference.

If it is determined that the object and the virtual object have interfered, the mixed-reality display processing apparatus can determine whether an area of the interference between the object and the virtual object is within the visual field of the user. If it is determined that the interference area is not within the visual field, the mixed-reality display processing apparatus can vibrate the vibration apparatuses of the plurality of users. If it is determined that the interference area is within the visual field, the mixed-reality display processing apparatus can highlight the interference area within the mixed video to display the heighted interference area on a display apparatus such as a large-screen display.

Embodiments of the present invention have been described above in detail with reference to specific exemplary embodiments. However, the present disclosure is not limited to the details of the exemplary embodiments described above.

For example, the software configuration of the above-described mixed reality system can be partially or entirely mounted as hardware. Moreover, the above description of the hardware configuration is merely one example. The mixed reality system may include a plurality of CPUs, memories, and communication I/Fs.

Moreover, the exemplary embodiments and the modification examples described above may be optionally combined.

According to each of the exemplary embodiments, therefore, a state of interference between a virtual object and a real object cart be shared in a realistic manner.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM) a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-126862, filed Jun. 24, 2015, which is hereby incorporated by reference herein in its entirety.

What is claimed is:

1. An information processing apparatus connected to a first display apparatus that is mounted on or held with one portion of a body of a first user and displays a virtual object and to a second display apparatus that is mounted on or held with one portion of a body of a second user different from the first user and displays an image corresponding to an image displayed on the first display apparatus, the information processing apparatus comprising:
a determination unit configured to determine whether the body of the first user or an object held by the first user satisfies a predetermined condition; and
an output unit configured, if the determination unit determines that the body of the first user or the object held by the first user satisfies the predetermined condition, to output a determination result to the second display apparatus.

2. The information processing apparatus according to claim 1, wherein the determination unit determines whether interference between the body of the first user or the object held by the first user and the virtual object is present.

3. The information processing apparatus according to claim 2, wherein, if an area occupied by the body of the first user or the object held by the first user overlaps an area occupied by the virtual object, the determination unit determines that the interference is present.

4. The information processing apparatus according to claim 2, wherein, if the determination unit determines that the interference is present, the output unit vibrates the second display apparatus to output the presence of the interference to the second user.

5. The information processing apparatus according to claim 2, further comprising a second determination unit configured, if the determination unit determines that the interference is present, to determine whether an area of the interference is within a visual field of the first user,
wherein, if the second determination unit determines that the interference area is not within the visual field, the output unit outputs the presence of the interference to a user of an information terminal.

6. The information processing apparatus according to claim 5, further comprising a highlight unit configured to highlight the interference area in a mixed video if the second determination unit determines that the interference area is within the visual field.

7. The information processing apparatus according to claim 1, wherein the first display apparatus is mounted on a head of the first user.

8. The information processing apparatus according to claim 7, wherein the second display apparatus is held with a hand of the second user.

9. The information processing apparatus according to claim 7, wherein the second display apparatus is mounted on a head of the second user.

10. The information processing apparatus according to claim 1, further comprising a generation unit configured to generate a virtual object to be displayed on the first display apparatus based on a position and orientation of the first display apparatus.

11. The information processing apparatus according to claim 1, wherein the object held by the first user includes a real object held with a hand of the first user.

12. The information processing apparatus according to claim 1, wherein the first display apparatus further includes an image capturing unit, and
wherein the first display apparatus displays a combined image formed by combining a real-space image captured by the image capturing unit and a virtual object.

13. The information processing apparatus according to claim 12, wherein the second display apparatus further includes an image capturing unit, and
wherein the second display apparatus displays a combined image formed by combining a real-space image captured by the image capturing unit and a virtual object.

14. The information processing apparatus according to claim 1, wherein the first display apparatus displays an image that is identical to an image displayed on the first display apparatus.

15. A control method for controlling an information processing apparatus connected to a first display apparatus that is mounted on or held with one portion of a body of a first user and displays a virtual object and to a second display apparatus that is mounted on or held with one portion of a body of a second user different from the first user and displays an image corresponding to an image displayed on the first display apparatus, the control method comprising:
determining whether the body of the first user or an object held by the first user satisfies a predetermined condition; and
outputting a determination result to the second display apparatus, if the determining determines that the body of the first user or the object held by the first user satisfies the predetermined condition.

16. A storage medium storing a program for causing a computer to function as each unit of an information processing apparatus connected to a first display apparatus that is mounted on or held with one portion of a body of a first user and displays a virtual object and to a second display apparatus that is mounted on or held with one portion of a body of a second user different from the first user and displays an image corresponding to an image displayed on the first display apparatus, the information processing apparatus comprising:
a determination unit configured to determine whether the body of the first user or an object held by first user satisfies a predetermined condition; and
an output unit configured, if the determination unit determines that the body of the first user or the object held by the first user satisfies the predetermined condition, to output a determination result to the second display apparatus.
